(19) United States
(12) Patent Application Publication
(10) Pub. No.: US 2005/0051219 A1
(43) Pub. Date: Mar. 10, 2005

(54) Water softener manifold retainer assembly

(75) Inventors: Keith Peltason, Schaumburg, IL (US); Lonnie Webb, Waterford, WI (US)

Correspondence Address: GREER, BURNS & CRAIN, 300 S WACKER DR, 25TH FLOOR, CHICAGO, IL, 60606, US

(73) Assignee: USF Consumer & Commercial WaterGroup, Inc.

(21) Appl. No.: 10/657,935

(22) Filed: Sep. 8, 2003

(51) Int. Cl. G05D 7/00

(52) U.S. Cl. 137/592

(57) ABSTRACT

A retainer assembly for maintaining the position of a manifold in a tank includes a seat configured for attachment adjacent an end of the manifold. A retainer base is configured for engaging the seat, which retains the base relative to the manifold. At least one retaining protrusion is securable to the base for movement between a first, retracted position and a second, extended position.

### FIELD OF THE INVENTION

The present invention relates generally to water treatment tanks of the type used in water softening and/or filtering systems. More particularly, the present invention relates to retainer assemblies for preventing the movement of a manifold out of such a treatment tank when a valve head is removed from the tank.

### BACKGROUND OF THE INVENTION

Water treatment tanks are known and used to condition or soften water. Conventional tanks have a tank head that provides an inlet and an outlet for the water flow through penetrating fittings or collars. In these conventional tanks, as water enters the tank through an inlet, it is directed through a media or bed of resin beads. At the bottom of the bed, treated water flows from the bottom of the tank into a tubular manifold to the top of the tank. In other embodiments, untreated water is introduced at the bottom of the tank and flows upwardly. In either embodiment, the treated water then exits the tank through an outlet conduit connected to a valve.

In conventional treatment tanks of this type, one large central opening on the tank head provides pathways for the inlet and outlet flow. A valve connected to the tank head provides corresponding inlet and outlet passages.

When the control valve is lifted from the tank head for service, the outlet conduit often remains connected to the manifold so that the manifold is pulled out of the tank upon removal of the valve. The manifold may also rotate from forces being exerted on the tank head and valve. As the manifold is lifted upward, its position inside the tank is disturbed, allowing resin beads to move underneath it. Due to the density of the resin in the tank, once withdrawn it is extremely difficult to replace the manifold back into position within the resin without first emptying the tank, which wastes time and resources.

Additionally, the inlet water flow of a conventional water softener tank travels adjacent to the manifold. It has been found that water entering the tank for treatment flows through the media closer to the manifold than media located farther away from the manifold. This inlet water flowing directly adjacent to the manifold, in a process also known as channeling, causes premature exhaustion of the media. When the water treatment tank experiences increasingly low water flow in the service position, the channeling described above is more noticeable or problematic. That water then flows through the “channels” near the manifold where the media is either close to saturation or exhausted. Thus, the water treatment system becomes inefficient because of the premature bypass of unconditioned water through the treatment media.

Thus, there is a need for an improved water softener retainer assembly configured for preventing vertical movement of the manifold when the valve head is removed from the tank head.

A further need is for an improved water softener retainer assembly which overcomes the channeling problem and allows the water treatment system to operate more efficiently at lower water flow rates.

### SUMMARY OF THE INVENTION

The above-listed needs are met or exceeded by the present manifold retainer assembly. To provide a retainer assembly which prevents vertical movement of the manifold, a seat is attached to the manifold for receiving a retainer base. The retainer base is disposed on top of the seat. At least one, and preferably a plurality of retaining protrusions are positioned in an extended position and secured to the retainer base. In this extended position, the retaining protrusions extend beyond the peripheral edges of the retainer base. Additionally, the retaining protrusions are in close proximity to the underside of the tank head, preventing vertical movement of the manifold.

More specifically, a retainer assembly is provided for maintaining the position of a manifold in a tank and includes a seat configured for attachment adjacent an end of the manifold, a retainer base configured for engaging the seat, which retains the base relative to the manifold, and at least one retaining protrusion securable to the base for movement between a first, retracted position and a second, extended position.

In another embodiment, a retainer assembly for maintaining the position of a manifold in a tank includes a plurality of retaining protrusions, a retainer base including a plurality of installation tabs, a plurality of appendages, a plurality of receiving housings, each configured for receiving a retaining protrusion, at least one depending mating portion, a seat fixable to the manifold, and having at least one notch for securably receiving the depending mating portion of the retainer base.

### BRIEF DESCRIPTION OF THE DRAWINGS

FIG. 1 is a fragmentary front perspective view of a treatment tank incorporating the assembled retainer assembly;

FIG. 2 is a fragmentary exploded front view of the assembly of FIG. 1;

FIG. 3 is a top perspective view of the retainer base; and

FIG. 4 is fragmentary top view of the retainer assembly.

### DETAILED DESCRIPTION OF THE INVENTION

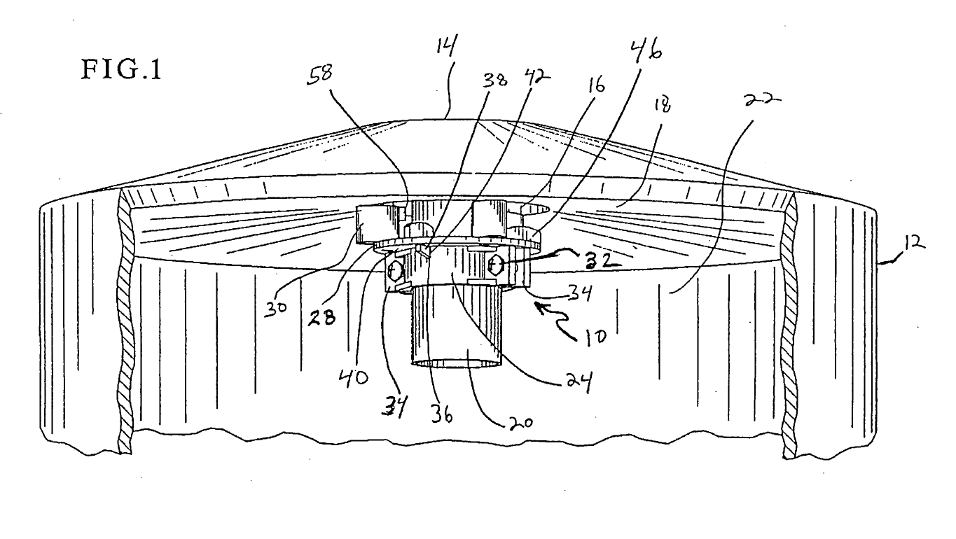

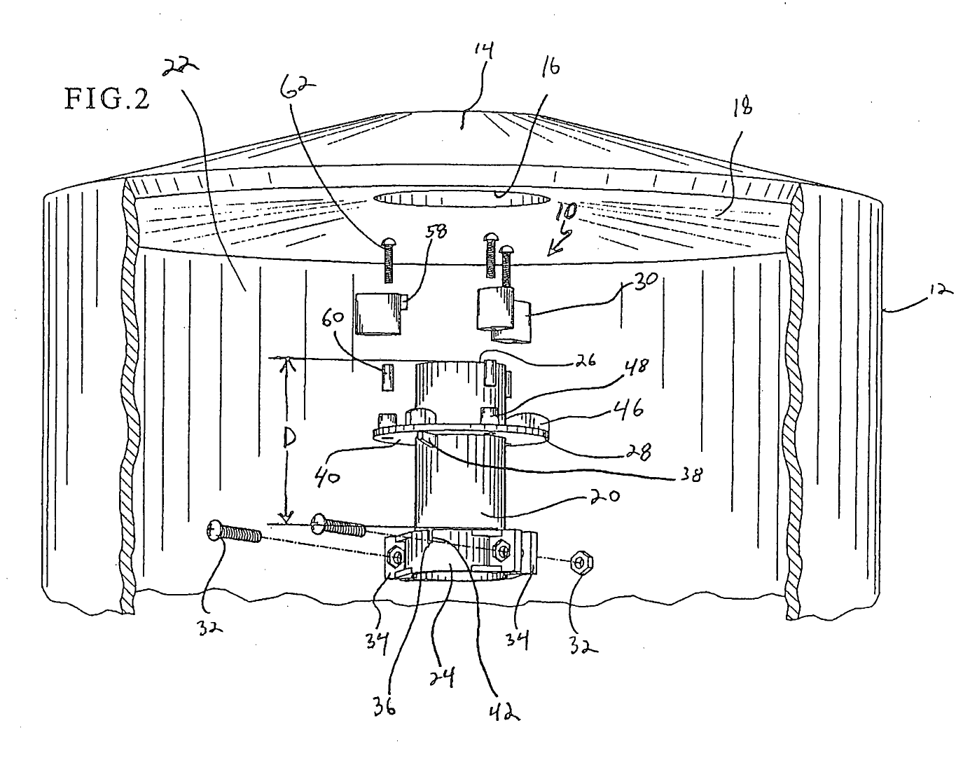

Referring now to FIGS. 1 and 2, a retainer assembly for a water softener is generally designated 10. As is well known in the art, water softener treatment tanks include an enclosed chamber in which a supply of resin media is contained. As hard water passes through the media, Ca⁺ and Mg⁺ ions are bonded to media and replaced by Na⁺ ions. Examples of such water softener treatment tanks are described in U.S. Pat. No. 6,032,821, which is hereby incorporated by reference. As described above, in many conventional treatment tanks, when a control valve is removed from a tank head, a manifold becomes stuck to the valve. The valve rotates due to threaded valve design and is lifted during and after rotation. This movement often causes vertical and/or rotational forces to be applied to the manifold and may cause movement of the manifold. As the manifold moves or rotates, the media surrounding the manifold falls underneath it, making an almost impossible task of placing the manifold back in its original position without emptying the tank.

A water softener treatment tank 12 includes a tank head 14 having a tank head opening 16 and an underside 18. A manifold pipe 20 is inserted through the tank opening 16 and into a hollow chamber 22 of the tank 12. The manifold 20 allows treated water to travel from the bottom of the tank 12 to the top of the tank 12 where the water then exits. As described above, in some treatment tanks, the untreated water flows through the manifold 20 to the bottom of the tank 12 and percolates upward through the media. Attached to the manifold 20, the retainer assembly 10 has a seat 24 configured for attachment adjacent an end 26 (FIG. 2) of the manifold 20, a retainer base 28 configured for engaging the seat, which retains the base 28 relative to the manifold 20, and at least one retaining protrusion 30 securable to the base 28 for movement between a first, retracted position and a second, extended position.

In the preferred embodiment, the seat 24, the retainer base 28, and the retaining protrusion 30 are preferably made of an environmentally resistant material. Injection-molded plastics are preferred; however, alternative known materials and/or fabrication or production techniques are contemplated. The seat 24 is configured for maintaining the base 28 a specific distance from the end 26 (FIG. 2) of the manifold 20, and for preventing relative rotation between the base 28 and the manifold 20. Preferably, the seat 24 is secured to the manifold 20 by at least one fastener 32 such as a screw, a bolt and a nut, a rivet, chemical adhesives, ultrasonic welding, or the like. In the preferred embodiment, the seat 24 is of a clamping type, however other types such as molded to the manifold 20, or welded, or the like are also contemplated. FIG. 2 illustrates the fastener 32 as a screw and a nut that are tightened to fasten the seat 24 to the manifold 20. Additionally, the use of screws and nuts allows the seat 24 to be released from the manifold 20. The screws and nuts are housed at peripheral ends 34 of the seat 24.

Preferably, the seat 24 is attached to the manifold 20 before the manifold 20 is placed into the tank 12 through the tank head opening 16. However, it is also contemplated that the entire retainer assembly 10 may be assembled on the manifold 20 before it is placed into the tank 12. Upon attachment to the manifold 20, the seat 24 defines a vertical displacement ‘D’ between the base 28 relative to the end 26 of the manifold 20 (FIG. 2). Preferably, the displacement ‘D’ is such that when the base 28 is engaged with the seat 24, each retaining protrusion 30 is in close or contacting proximity with the underside 18 of the tank head 14, as shown in FIG. 1. Without proper contact between the retaining protrusion 30 and the underside 18 of the tank head 14, vertical movement of the manifold 20 is possible. In the preferred embodiment, there are three retaining protrusions 30 that disperse the vertical force equally so that tilting of the manifold 20 does not occur.

Additionally, the seat 24 includes at least one notch 36 for receiving the retainer base 28 and for preventing relative rotation of the base 28 and the seat 24. In the preferred embodiment, the seat 24 includes a 180 degree displacement of a plurality of notches 36. Each notch 36 is configured for receiving a depending protrusion 38 located on a second or underside surface 40 of the retainer base 28. Proper alignment of the base 28 with the seat 24 is made possible by each notch 36 acting as a reference point for the base 28. As each depending protrusion 38 engages each notch 36 of the seat 24, the side walls 42 of each notch 36 are slidingly engaged by the protrusion 38. Preferably, the number of depending protrusions 38 corresponds to the number of notches 36 disposed on the seat 24.

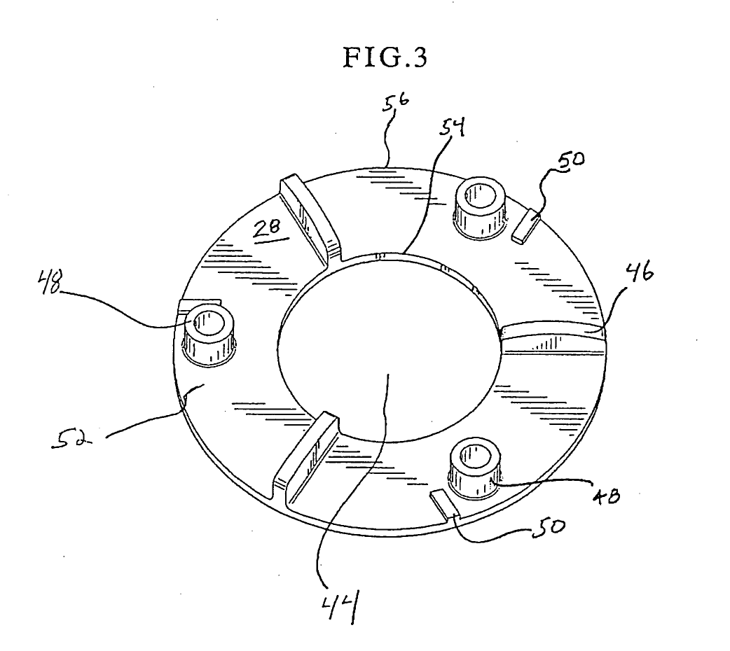

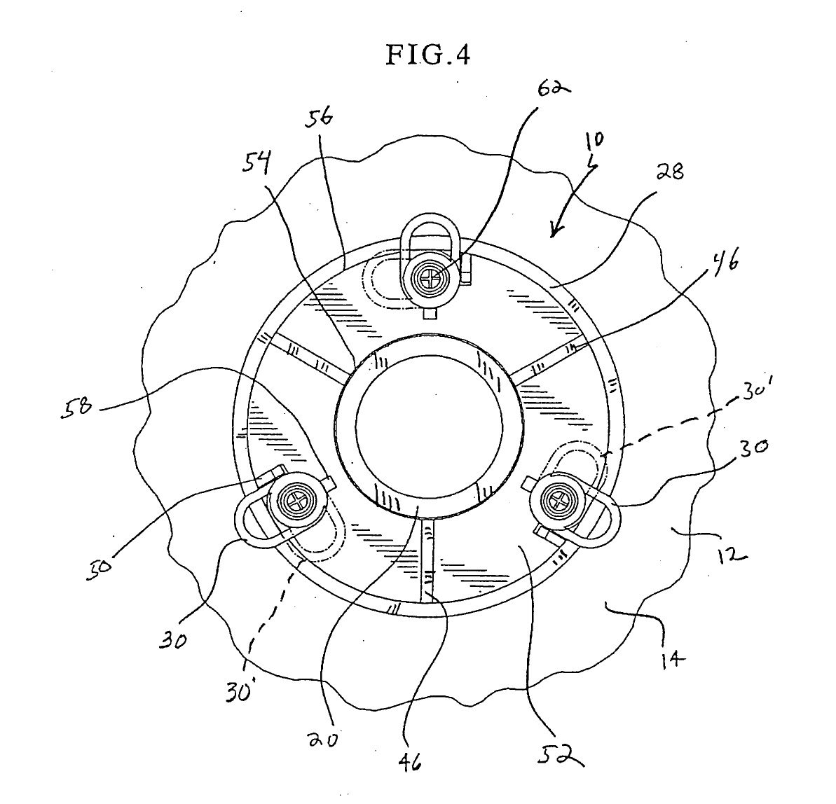

Referring now to FIGS. 1, 2 and 3, in a preferred embodiment, the retainer base 28 includes a passage 44 (FIG. 3) for receiving the manifold 20, at least one appendage 46, at least one depending protrusion 38 (FIGS. 1 and 2), at least one hollow boss 48 (FIGS. 2 and 3), and at least one positioning stop 50 (FIG. 3). The passage 44 is dimensioned for allowing the base 28 to slide down the manifold 20 and onto the seat 24. However, before the base 28 is slid down the manifold 20, each retaining protrusion 30 is preferably placed on the base 28 in a first, retracted position (shown phantom in FIG. 4). In this position, both the base 28 and each retaining protrusion 30 are dimensioned to pass through the tank head opening 16.

Each of the appendages 46 is located on a first, preferably upper surface 52 of the retaining base 28. Preferably, each appendage 46 extends from an inner peripheral edge 54 to an outer peripheral edge 56 of the retainer base 28. In the preferred embodiment, each appendage 46 is a rib configured for providing structural support for the retainer base 28. Additionally, each appendage 46 is configured for being engaged by a tool such as pliers which grasps the base 28 at these points during installation and removal.

Each of the hollow bosses 48 is preferably disposed on the same upper surface 52 of the base 28 as are the appendages 46 (FIG. 3). In the preferred embodiment, the hollow boss 48 is configured for pivotably receiving the retaining protrusion 30. Each retaining protrusion 30 preferably includes an installation tab 58 that is configured for assisting in pivoting each retaining protrusion 30 around the hollow boss 48. The tab 58 extends outward from the back of each protrusion 30 and may be pushed from its side, thereby, pivoting the retaining protrusion 30 around the hollow boss 48. As the retaining protrusion 30 is received by the hollow boss 48, a bottom of the retaining protrusion 30 rests upon the first surface 52 of the base 28.

A threaded sleeve 60 is disposed inside of the hollow boss 48, allowing the retaining protrusion 30 to be secured to the base 28 with threaded fasteners. Preferably, the threaded sleeve 60 is made from an environmentally resistant metal or metal alloy such as stainless steel, brass, etc. When the retaining protrusion 30 is in its desired position, a fastener 62 such as a screw secures the retaining protrusion 30 by engaging the threaded sleeve 60 as it is tightened. Additionally, the fastener 62 secures the retaining protrusion 30 by threadably engaging the base 28 in its first or second position.

Referring now to FIGS. 3 and 4, a maximum distance of outward movement of the retaining protrusion 30 is defined by the positioning stop 50. Preferably, the positioning stop 50 terminates the movement of each retaining protrusion 30 when the tab 58 is parallel with a radial line extending from the center of the retaining base 28. Maximum extension of each retaining protrusion 30 beyond the outer peripheral edge 56 of the base 28 occurs at the point where the positioning stop 50 terminates the outward movement of each retaining protrusion 30. Additionally, the maximum extension of the retaining protrusion 30 allows for a maximum point of contact between each protrusion 30 and the underside 18 of the tank head 14.

Preferably, the retainer base 28 is slid down the manifold 20 with each retaining protrusion 30 in an inward position as shown by the phantom retaining protrusion 30′ in FIG. 4. Once the retainer base 28 is aligned with the seat 24 and slid into place, each tab 58 allows for each retaining protrusion 30 to be easily pivoted to its final outward position defined by the positioning stop 50.

The final outward position of each retaining protrusion 30 is defined by extending the protrusion 30 to a second, extended position beyond the peripheral edge 56 of the retaining base 28 (shown in solid in FIG. 4). Each retaining protrusion 30 is configured so that upon reaching the second position, the manifold 20 is prevented from vertical movement in the tank 12. At the second position, the top surface of the retaining protrusion 30 is in close proximity to the underside 18 of the tank head 14. As a vertical force is applied to the manifold 20, the retaining protrusion 30 comes into contact with the underside 18 of the tank head 14, keeping the manifold 20 in place. Once each protrusion 30 is in the second, extended position, the fasteners 62 are tightened to secure the assembly 10, and the manifold 20, in place.

In conclusion, an improved retainer assembly 10 has been described that prevents vertical movement of the manifold 20. As the control valve is lifted off of the tank head 14, a vertical or rotational force is applied to the manifold 20. Contacting the underside 18 of the tank head 14, the retainer assembly 10 opposes the forces and prevents the manifold 20 from moving. Rotational movement of the retaining base 28 relative to the manifold 20 and the seat 24 is prevented by the notches 36 on the seat 24 being slidingly engaged by the depending protrusions 38 of the base 28.

Additionally, the configuration of the assembled retainer assembly 10 diverts the inlet water flow away from the manifold 20. As the water enters the tank head opening 16, it encounters the retainer assembly 10, which deflects the water to flow away from the center of the tank 12 and distribute more evenly throughout the tank 12. Channeling is thus avoided at the media closest to the manifold 20 because the water does not travel adjacent to the manifold 20.

While a particular embodiment of the improved retainer assembly of the present invention has been shown and described, it will be appreciated by those skilled in the art that changes and modifications may be made thereto without departing from the invention in its broader aspects as set forth in the following claims.

1. A retainer assembly for maintaining the position of a manifold in a tank, comprising:
a seat configured for attachment adjacent an end of the manifold;
a retainer base configured for engaging said seat, said seat retaining said base relative to the manifold; and
at least one retaining protrusion securable to said base for movement between a first, retracted position and a second, extended position.

2. The assembly according to claim 1, wherein the tank has an opening and when in said first position, said base and said at least one retaining protrusion are dimensioned to pass through the opening.

3. The assembly according to claim 1, wherein said seat is configured for maintaining said base a specific distance from an end of the manifold, and for preventing relative rotation between said base and the manifold.

4. The assembly according to claim 3, wherein said seat is comprised of at least one notch for receiving said retainer base, and for preventing said relative rotation.

5. The assembly according to claim 1, wherein said seat is secured to said manifold by a fastening means.

6. The assembly according to claim 5, wherein upon attachment to the manifold, said seat defines a vertical displacement between said base relative to an end of the manifold.

7. The assembly according to claim 1, wherein said retainer base has a passage configured for receiving the manifold.

8. The assembly according to claim 1, wherein said retainer base includes at least one appendage.

9. The assembly according to claim 1, wherein said retainer base includes at least one hollow boss.

10. The assembly according to claim 1, wherein said retainer base includes at least one positioning stop.

11. The assembly according to claim 1, further including at least one retaining protrusion, and wherein said retainer base further includes:
a passage for receiving the manifold;
at least one appendage extending from a first surface of said base;
at least one protrusion depending from a second surface of said base;
at least one hollow boss, each configured for receiving one of said retaining protrusions; and
at least one positioning stop defining a maximum distance of outward movement of said retaining protrusions.

12. The assembly according to claim 11, wherein said at least one appendage is a rib configured for providing structural support for said retaining base.

13. The assembly according to claim 11, wherein said at least one protrusion is configured for engaging said seat to prevent relative rotation between said base and said seat.

14. The assembly according to claim 11, further including a threaded sleeve disposed inside each hollow boss.

15. The assembly according to claim 11, wherein said at least one retaining protrusion is pivotably engageable on said hollow boss.

16. The assembly according to claim 15, wherein said at least one retaining protrusion is configured so that upon reaching said second position, the manifold is prevented from vertical movement in the tank.

17. The assembly according to clam 15, further comprising at least one fastener, configured for securing said at least one retaining protrusion by threadably engaging said base in one of said first and second positions.

18. A retainer assembly for maintaining the position of a manifold in a tank, comprising:
a plurality of retaining protrusions;
a retainer base having a plurality of installation tabs, a plurality of appendages, a plurality of receiving housings, each configured for receiving one of said retaining protrusions, and at least one depending mating portion; and
a seat fixable to the manifold, and having at least one notch for securably receiving said depending mating portion of said retainer base.

19. The retainer assembly according to claim 18, wherein the tank includes a tank head having an opening and an underside, wherein a top surface of said retaining protrusion is located in a close proximity to the underside of the tank head preventing vertical movement of said manifold.

20. The retainer assembly according to claim 18, wherein said seat engages said retainer base preventing rotational movement of said retainer assembly.
